(19) United States
(12) Patent Application Publication
(10) Pub. No.: US 2014/0244987 A1
(43) Pub. Date: Aug. 28, 2014

(54) Precision Exception Signaling for Multiple Data Architecture

(71) Applicant: MIPS TECHNOLOGIES, INC., Sunnyvale, CA (US)

(72) Inventors: Ilie GARBACEA, Santa Clara, CA (US); James ROBINSON, New York, NY (US)

(73) Assignee: MIPS Technologies, Inc., Sunnyvale, CA (US)

(21) Appl. No.: 13/773,818

(22) Filed: Feb. 22, 2013

(51) Int. Cl. G06F 9/30

(52) U.S. Cl. CPC G06F 9/30
USPC 712/244

(57) ABSTRACT

Methods and systems that perform one or more operations on a plurality of elements using a multiple data processing element processor are provided. An input vector comprising a plurality of elements is received by a processor. The processor determines if performing a first operation on a first element will cause an exception and if so, writes an indication of the exception caused by the first operation to a first portion of an output vector stored in an output register. A second operation can be performed on a second element with the result of the second operation being written to a second portion of the output vector stored in the output register.

### BACKGROUND

1. Field of the Invention

The invention is generally related to systems and methods for performing one or more operations on one or more elements using a multiple data processing element processor.

2. Related Art

Multiple data processing element processors, e.g., a single instruction multiple data (SIMD) or multiple instruction multiple data (MIMD), receive multiple data inputs, operate on the inputs, and output the results of the operation to, for instance, an output register. As an example, such a processor might receive inputs a, b, c, and d and add them together to produce the results a+b and c+d. Occasionally, performing the prescribed operation on one or more of the data inputs is problematic for the processor and it generates an exception. This happens, for instance, when the prescribed operation is not implemented for the processor for the inputs provided. In such a scenario, the processor would be unable to perform this operation and would generate an exception.

When an exception occurs, typically no results are written to the output register and the exception is handled by an exception handler using software emulation, for instance, to perform the operation on the data inputs or to deal with the exception in some other way. The problem with this method is that it can be slow and resource intensive. Furthermore, in many instances only a few of the multiple data inputs cause an exception when the operation is performed; the majority of the data inputs do not cause an exception when the operation is performed. However, the processing of an exception typically also delays the processing of data that is not associated with the exception as the exception handler cannot discern which data inputs are the cause of the exception.

### BRIEF SUMMARY OF THE INVENTION

What is needed, therefore, are systems and methods that allow more precise exception signaling so that an exception handler need only handle the data associated with a valid exception while allowing the data inputs that are not the cause of an exception to be timely processed by one or more processing elements. According to embodiments of the invention, a method of performing one or more operations on a plurality of elements using a multiple data processing element processor is provided. An input vector comprising a plurality of elements is received by a processor. The processor determines if performing a first operation on a first element will cause an exception and if so, writes an indication of the exception caused by the first operation to a first portion of an output vector stored in an output register. A second operation can be performed on a second element with the result of that second operation being written to a second portion of the output vector stored in the output register.

Embodiments of the invention include a multiple data processing element processor. The system includes an input register, an output register, and a multiple data processing element processor. The input register can be configured to store an input vector comprising a plurality of elements. The output register can be configured to store the results of a plurality of operations. The processor is configured to receive the input vector from the input register, and determine that performing a first operation on a first element will cause an exception and output an indication of the exception caused by the first operation to a first portion of an output vector stored in the output register. Additionally, the processor can be configured to perform a second operation on a second element and output the result of the second operation to a second portion of the output vector stored in the output register.

Some embodiments of the invention include a method of performing an operation on a plurality of elements using a multiple data processing element processor. The method includes receiving an input vector that includes a first and a second element and determining that the performing of a first operation on a first element will cause an exception. In this case the method continues by writing an indication of the exception cause by the first operation to a first portion of an output vector stored in an output register. Further, the method includes performing a second operation on the second element and writing a result of the second operation to a second portion of the output vector stored in the output register.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 depicts a multiple data processing element system according to various embodiments of the invention.

FIGS. 2a and 2b depict multiple data operations according to various embodiments of the invention.

FIG. 3 illustrates a method of processing data elements according to various embodiments of the invention.

FIG. 4 illustrates a method of processing data elements according to various embodiments of the invention.

FIG. 5 illustrates a method of processing data elements according to various embodiments of the invention.

FIG. 6 depicts a processor architecture according to various embodiments of the invention.

Features and advantages of the invention will become more apparent from the detailed description of embodiments of the invention set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION

The following detailed description of embodiments of the invention refers to the accompanying drawings that illustrate exemplary embodiments. Embodiments described herein relate to a low power multiprocessor. Other embodiments are possible, and modifications can be made to the embodiments within the spirit and scope of this description. Therefore, the detailed description is not meant to limit the embodiments described below.

It should be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

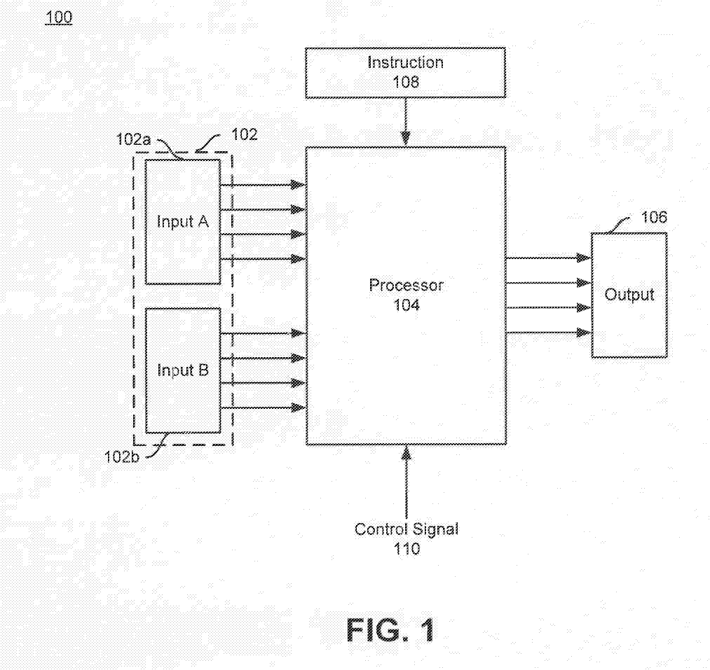

FIG. 1 depicts a system 100 that can provide precise exception handling according to embodiments of the invention. System 100 includes a processor 104, input A 102a, and input B 102b (collectively referred to as input 102 herein). Processor 104 can output the results of an operation to output register 106. Instruction register 108 can contain an instruction or instructions indicating what operation the processor is to perform on the input data elements contained in input 102.

Inputs 102a and 102b may each comprise one or more registers capable of storing one or more input vectors. Additionally, according to some embodiments, the processor can be provided with a single input vector 102 stored on a single register. The input vectors can each include a number of data elements for processing by the processor. For instance, the processor 104 may perform an operation on a set of one or more elements to produce a result. As an example, assume input 102 contains elements x and y. Processor 104 may be configured to perform operation f on elements x and y and produce a result z such that z=f(x,y). Processor 104, however, can be configured to perform an operation on any number of elements from input 102.

Processor 104 may comprise a multiple data processing element processor such as a single instruction multiple data (SIMD) processor according to some embodiments. Additionally, the processor 104 may comprise a multiple instruction multiple data (MIMD) processor. The processor can be configured to perform a number of different operations (e.g., add, subtract, divide, multiply, shift, etc.) based on the instruction input 108. The processor can also be configured to output the result of the operation to the output register 106.

Processor 104 may be configured to receive a control signal 110 that controls whether the processor operates in a non-signaling exception mode according to various embodiments. When the processor is not operating in a non-signaling exception mode, processor 104 can be thought of operating in a “normal” mode. That is, when an exception is generated by operation on any of the elements, the processor signals the exception and an exception handler handles the operation for all the elements. However, when processor 104 is operating in non-signaling exception mode, the processor does not signal that an exception has occurred and, instead, indicates an exception in the output register only for the specific operations that caused the exception while allowing operation on the other elements to proceed and the result to be written to the output register.

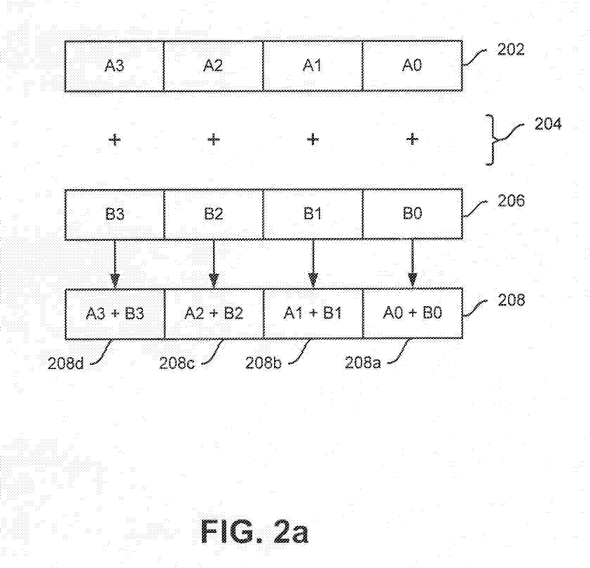

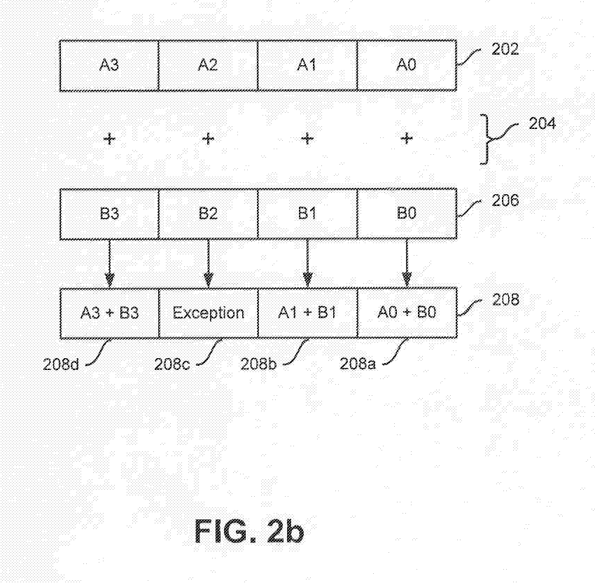

FIG. 2a illustrates an operation performed by processor 104. For instance, as depicted, processor 104 receives a first input vector 202 comprising elements A0, A1, A2, and A3. The vector may be of any length and may be stored in a register. As an example, if first input vector 202 is stored in a 64 bit register, then each of elements A0, A1, A2, and A3 may comprise 16 bits. Similarly to first input vector 202, second input vector 206 may also comprise a number of elements B0, B1, B2, and B3. Additionally, the second input vector 206 may be stored in a register of any length and need not be the same length as the register that stores first input vector 202.

According to embodiments of the invention, processor 104 can be configured to perform operations 204 on the elements in input vectors 202 and 206. Operations 204 can be defined by input instruction 108. In some embodiments (e.g., in embodiments where processor 104 is a SIMD processor), there will be only one instruction and the same operation will be performed on each of the input element pairs. This situation is depicted in FIG. 2a where each of the element pairs (i.e., A0 and B0, A1 and B1, etc.) is added together to achieve result vector 208. The output vector 208 may be organized into a number of results (e.g., 208a, 208b, 208c, and 208d), each corresponding to the result of performing the operation on one or more elements. According to other embodiments (e.g., MIMD embodiments), processor 104 may receive multiple instructions or an instruction vector and different operations may be performed on the various element pairs.

As with input vectors 202 and 206, result vector 208 may be stored in a register such as output register 106. While the output register may be of any size, it is preferably large enough to prevent overflow under any or most circumstances. For instance, output register may be larger than either of input vectors 202 and 206 according to aspects of the invention.

FIG. 2b illustrates a situation similar to that depicted by FIG. 202a, but where the performance of the operation on one of the element pairs causes an exception. According to embodiments, processor 104 operating on input vectors 202 and 206 may be operating in a non-signaling exception mode. As shown in FIG. 2b, the elements contained in input vectors 202 and 206 are added together as prescribed by operation 204. However, in this case, the addition of A2 to B2 causes an exception. The remaining results, however, do not cause an exception and are written to the corresponding result portion of output vector 208 in their corresponding locations 208a, 208b, and 208d. However, in place of a result, an indication that the addition of A2 and B2 caused an exception is written to the output vector at the corresponding location 208c. The exception indication may contain information identifying the exception that occurred (e.g., an exception code) as well as information about the elements that caused the exception.

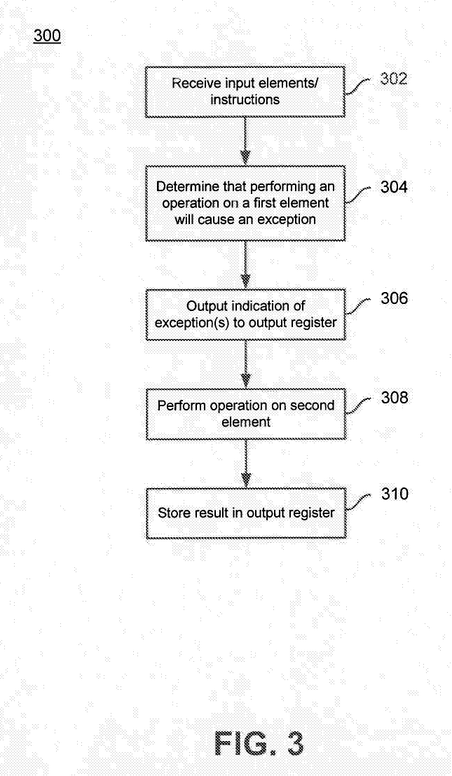

FIG. 3 illustrates a method 300 of processing data according to embodiments of the invention. At step 302 a processor can receive input elements in the form of one or more input vectors that each contain a number of elements. Additionally, the processor may receive one or more input instructions indicating an operation to be performed on the input elements. According to some embodiments the input vectors can be stored in one or more input registers.

At step 304, the processor determines that performing an operation on a first element or first set of elements will cause an exception. An indication that performing the operation on the first element or set of elements will cause an exception is output to a corresponding position in an output register at step 306. The operation on the second element can be performed at step 308 and the result of the operation on the second element stored in a corresponding location of an output register at step 310. According to some embodiments, steps 304 and 306 may be performed in parallel with steps 308 and 310.

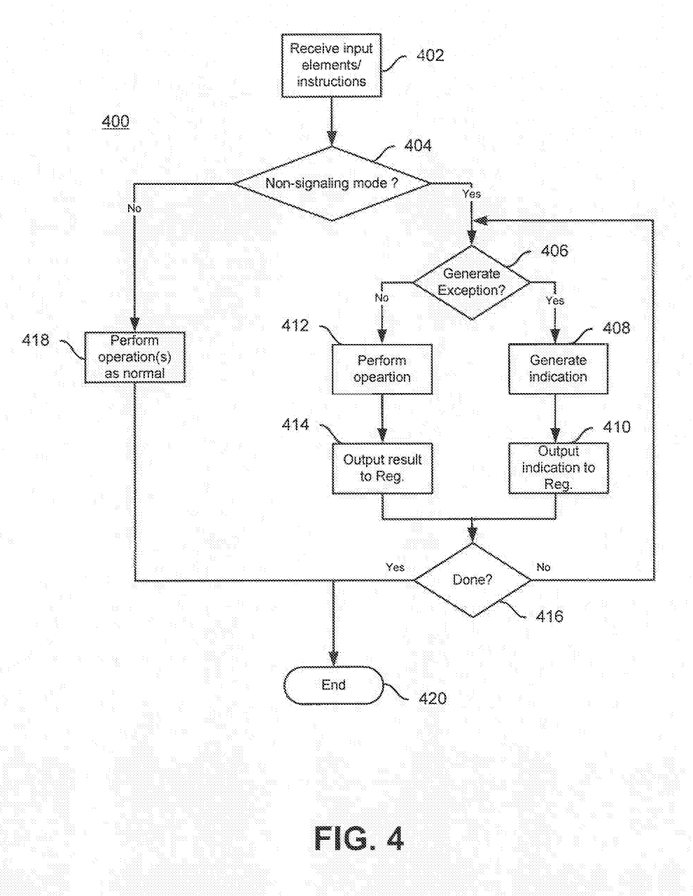

FIG. 4 illustrates a method 400 of processing data using in a processor according to embodiments of the invention. At step 402, the processor receives input elements. The input elements can be part of one or more input vectors and stored in one or more input registers according to various embodiments. Additionally, the processor may receive one or more input instructions indicating the operation that the processor is to perform on the elements.

At step 404, the processor determines whether a non-signaling exception mode has been enabled or not. The mode can be enabled or disabled by setting or unsetting a control bit in the processor according to various embodiments. If the mode is disabled, then the processor performs the operation or operations on the elements according to a normal exception signaling method at step 418. That is, when an exception occurs, the processor signals an exception and allows an exception handler to perform the operation or operations on all of the input elements regardless of which element or set of elements caused the exception.

If it is determined that the non-signaling mode is enabled at step 404, then the processor determines whether an element or set of elements will generate an exception at step 406. If the element or set of elements will generate an exception, then the processor generates an indication of the exception at step 408 and outputs the indication to an output register at step 410. According to embodiments, the indication can identify the elements and the operation that caused the exception. If it is determined that the element or set of elements will not cause an exception, then the operation is performed at step 412 and the result of the operation on the element or elements is output to the output register at step 414. At step 416, the method loops back to step 406 if there are more elements to consider, otherwise it ends at 420. While FIG. 4 depicts steps 406-414 being performed sequentially for each element or set of elements, these steps could be performed simultaneously for each of the elements or sets of elements.

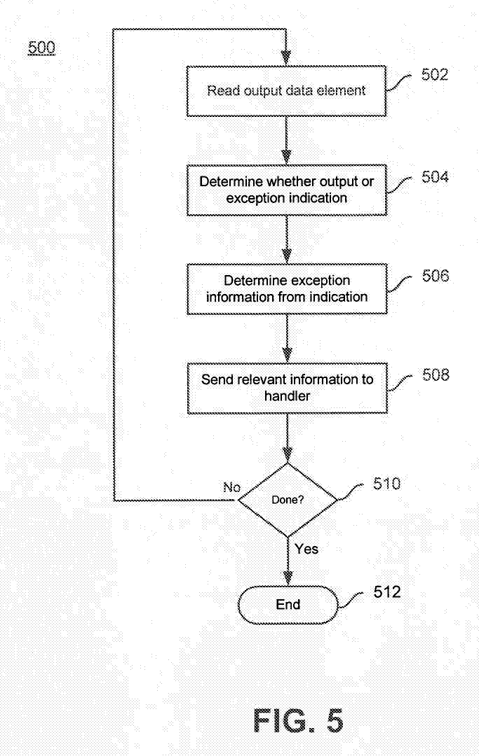

FIG. 5 illustrates a method 500 of identifying the exceptions that have occurred in an output vector according to embodiments of the invention. At step 502, the output data element is read from the output register or vector. It can then be determined whether the data element contains the result of an operation or an indication of exception. At step 504, if the result is an indication of exception, the appropriate exception information can be determined from the indication at step 506. For instance, the indication might contain an exception code and information about the element or elements as well as the operation that caused the exception. At step 508, the relevant information relating to the exception can be sent to an exception handler so that it may handle the exception by, for instance, software emulation. At step 510, the process determines if all of the output data has been read. If not, then the method 500 loops back to step 502 and repeats for the next element in the output register. If, however, at step 510, the method 500 determines that all of the output elements have been read, then the process ends at step 512.

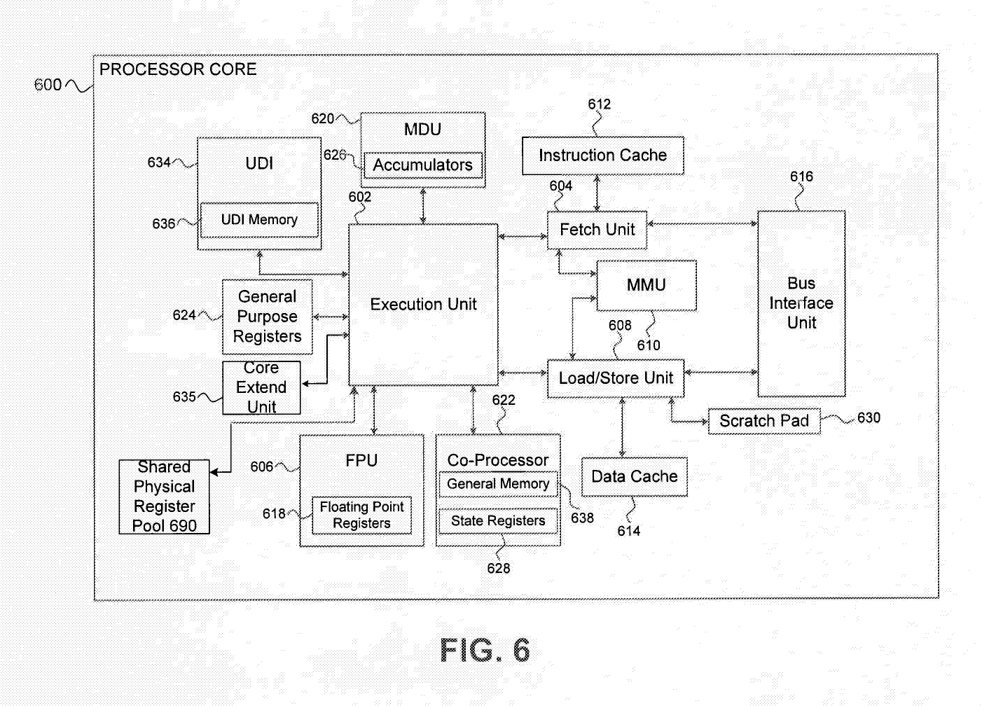

It will be appreciated that various embodiments may be implemented or facilitated by or in cooperation with hardware components enabling the functionality of the various software routines, modules, elements, or instructions. Example hardware components are described further with respect to FIG. 6 below, e.g., processor core 600 that includes an execution unit 602, a fetch unit 604, a floating point unit 606, a load/store unit 608, a memory management unit (MMU) 610, an instruction cache 612, a data cache 614, a bus interface unit 616, a multiply/divide unit (MDU) 620, a co-processor 622, general purpose registers 624, a scratch pad 630, and a core extend unit 634.

While various embodiments of the present invention have been described above, it should be understood that they have been presented by way of example, and not limitation. It will be apparent to persons skilled in the relevant computer arts that various changes in form and detail can be made therein without departing from the spirit and scope of the invention. Furthermore, it should be appreciated that the detailed description of the present invention provided herein, and not the summary and abstract sections, is intended to be used to interpret the claims. The summary and abstract sections may set forth one or more but not all exemplary embodiments of the present invention as contemplated by the inventors.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (i.e., schematic) capture tools. Embodiments can be disposed in any known non-transitory computer usable medium including semiconductor, magnetic disk, optical disk (e.g., CD-ROM, DVD-ROM, etc.).

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalence. It will be appreciated that embodiments using a combination of hardware and software may be implemented or facilitated by or in cooperation with hardware components enabling the functionality of the various software routines, modules, elements, or instructions, e.g., the components noted above with respect to FIG. 1.

FIG. 6 is a schematic diagram of an exemplary processor core 600 according to an embodiment of the present invention for implementing a shared register pool. Processor core 600 is an exemplary processor intended to be illustrative, and not intended to be limiting. Those skilled in the art would recognize numerous processor implementations for use with an ISA according to embodiments of the present invention.

As shown in FIG. 6, processor core 600 includes an execution unit 602, a fetch unit 604, a floating point unit 606, a load/store unit 608, a memory management unit (MMU) 610, an instruction cache 612, a data cache 614, a bus interface unit 616, a multiply/divide unit (MDU) 620, a co-processor 622, general purpose registers 624, a scratch pad 630, and a core extend unit 634. While processor core 600 is described herein as including several separate components, many of these components are optional components and will not be present in each embodiment of the present invention, or components that may be combined, for example, so that the functionality of two components reside within a single component. Additional components may also be added. Thus, the individual components shown in FIG. 6 are illustrative and not intended to limit the present invention.

Execution unit 602 preferably implements a load-store (RISC) architecture with single-cycle arithmetic logic unit operations (e.g., logical, shift, add, subtract, etc.). Execution unit 602 interfaces with fetch unit 604, floating point unit 606, load/store unit 608, multiple-divide unit 620, co-processor 622, general purpose registers 624, and core extend unit 634.

Fetch unit 604 is responsible for providing instructions to execution unit 602. In one embodiment, fetch unit 604 includes control logic for instruction cache 612, a recoder for recoding compressed format instructions, dynamic branch prediction and an instruction buffer to decouple operation of fetch unit 604 from execution unit 602. Fetch unit 604 interfaces with execution unit 602, memory management unit 610, instruction cache 612, and bus interface unit 616.

Floating point unit 606 interfaces with execution unit 602 and operates on non-integer data. Floating point unit 606 includes floating point registers 618. In one embodiment, floating point registers 618 may be external to floating point unit 606. Floating point registers 618 may be 32-bit or 64-bit registers used for floating point operations performed by floating point unit 606. Typical floating point operations are arithmetic, such as addition and multiplication, and may also include exponential or trigonometric calculations.

Load/store unit 608 is responsible for data loads and stores, and includes data cache control logic. Load/store unit 608 interfaces with data cache 614 and scratch pad 630 and/or a fill buffer (not shown). Load/store unit 608 also interfaces with memory management unit 610 and bus interface unit 616.

Memory management unit 610 translates virtual addresses to physical addresses for memory access. In one embodiment, memory management unit 610 includes a translation lookaside buffer (TLB) and may include a separate instruction TLB and a separate data TLB. Memory management unit 610 interfaces with fetch unit 604 and load/store unit 608.

Instruction cache 612 is an on-chip memory array organized as a multi-way set associative or direct associative cache such as, for example, a 2-way set associative cache, a 4-way set associative cache, an 8-way set associative cache, et cetera. Instruction cache 612 is preferably virtually indexed and physically tagged, thereby allowing virtual-to-physical address translations to occur in parallel with cache accesses. In one embodiment, the tags include a valid bit and optional parity bits in addition to physical address bits. Instruction cache 612 interfaces with fetch unit 604.

Data cache 614 is also an on-chip memory array. Data cache 614 is preferably virtually indexed and physically tagged. In one embodiment, the tags include a valid bit and optional parity bits in addition to physical address bits. Data cache 614 interfaces with load/store unit 608.

Bus interface unit 616 controls external interface signals for processor core 600. In an embodiment, bus interface unit 616 includes a collapsing write buffer used to merge write-through transactions and gather writes from uncached stores.

Multiply/divide unit 620 performs multiply and divide operations for processor core 600. In one embodiment, multiply/divide unit 620 preferably includes a pipelined multiplier, accumulation registers (accumulators) 626, and multiply and divide state machines, as well as all the control logic required to perform, for example, multiply, multiply-add, and divide functions. As shown in FIG. 6, multiply/divide unit 620 interfaces with execution unit 602. Accumulators 626 are used to store results of arithmetic performed by multiply/divide unit 620.

Co-processor 622 performs various overhead functions for processor core 600. In one embodiment, co-processor 622 is responsible for virtual-to-physical address translations, implementing cache protocols, exception handling, operating mode selection, and enabling/disabling interrupt functions. Co-processor 622 interfaces with execution unit 602. Co-processor 622 includes state registers 628 and general memory 638. State registers 628 are generally used to hold variables used by co-processor 622. State registers 628 may also include registers for holding state information generally for processor core 600. For example, state registers 628 may include a status register. General memory 638 may be used to hold temporary values such as coefficients generated during computations. In one embodiment, general memory 638 is in the form of a register file.

General purpose registers 624 are typically 32-bit or 64-bit registers used for scalar integer operations and address calculations. In one embodiment, general purpose registers 624 are a part of execution unit 602. Optionally, one or more additional register file sets, such as shadow register file sets, can be included to minimize content switching overhead, for example, during interrupt and/or exception processing.

Scratch pad 630 is a memory that stores or supplies data to load/store unit 608. The one or more specific address regions of a scratch pad may be pre-configured or configured programmatically while processor core 600 is running. An address region is a continuous range of addresses that may be specified, for example, by a base address and a region size. When base address and region size are used, the base address specifies the start of the address region and the region size, for example, is added to the base address to specify the end of the address region. Typically, once an address region is specified for a scratch pad, all data corresponding to the specified address region are retrieved from the scratch pad.

User Defined Instruction (UDI) unit 634 allows processor core 600 to be tailored for specific applications. UDI 634 allows a user to define and add their own instructions that may operate on data stored, for example, in general purpose registers 624. UDI 634 allows users to add new capabilities while maintaining compatibility with industry standard architectures. UDI 634 includes UDI memory 636 that may be used to store user added instructions and variables generated during computation. In one embodiment, UDI memory 636 is in the form of a register file.

Embodiments described herein relate to a shared register pool. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method of performing one or more operations on a plurality of elements using a multiple data processing element processor, comprising:
receiving one or more input vectors, wherein the one or more input vectors comprise a first set of elements and a second set of elements;
determining that performing a first operation on the first set of elements will cause an exception;
writing an indication of the exception caused by the first operation to a first element of an output vector,
performing a second operation on the second set of elements; and
writing a result of the second operation to a second element of the output vector.

2. The method of claim 1, further comprising determining that a non-signaling exception mode is enabled in the processor.

3. The method of claim 1, wherein the one or more input vectors comprise a third set of elements.

4. The method of claim 3, further comprising determining that performing a third operation on the third set of elements will cause an exception and writing an indication of the exception to a third element of the output vector.

5. The method of claim 1, wherein the first and second operations are the same operation.

6. The method of claim 1, wherein the multiple data processing element processor is a single input multiple data (SIMD) processor.

7. The method of claim 1, wherein the multiple data processing element processor is a multiple input multiple data (MIMD) processor.

8. The method of claim 1, wherein the indication signals an exception handler to handle the exception.

9. The method of claim 1, wherein each of the first and second sets of elements contains a single element.

10. The method of claim 1, wherein each of the first and second sets of elements contains a plurality of elements.

11. A multiple data processing element system, comprising:
an input register configured to store one or more input vectors, wherein the one or more input vectors comprise a first set of elements and a second set of elements;
an output register configured to store the results of a plurality of operations; and
a multiple data processing element processor configured to:
receive the one or more input vectors from the input register,
determine that performing a first operation on the first set of elements will cause an exception and output an indication of the exception caused by the first operation to a first element of the output register, and
perform a second operation on a second set of elements and output the result of the operation to a second element of the output register.

12. The system of claim 11, wherein the processor is further configured to determine that a non-signaling exception mode is enabled in the processor.

13. The system of claim 11, wherein the one or more input vectors further comprise a third set of elements.

14. The system of claim 13, wherein the processor is further configured to determine that performing a third operation on the third set of elements will cause an exception and to output an indication of the exception to a third element of the output register.

15. The system of claim 11, wherein the first and second operations are the same operation.

16. The system of claim 11, wherein the multiple data processing element processor is a single input multiple data (SIMD) processor.

17. The system of claim 11, wherein the multiple data processing element processor is a multiple input multiple data (MIMD) processor.

18. The method of claim 11, wherein the indication is configured to signal an exception handler to handle the exception.

19. The system of claim 11, wherein each of the first and second sets of elements contains a single element.

20. The system of claim 11, wherein each of the first and second sets of elements contains a plurality of elements.
